(19) United States
(12) Patent Application Publication
(10) Pub. No.: US 2013/0140399 A1
(43) Pub. Date: Jun. 6, 2013

(54) MAIN LANDING GEAR OF AN AIRCRAFT, COMPRISING TWO WALKING BEAMS AND A DEFORMABLE PARALLELOGRAM STRUCTURE

(71) Applicant: Dominique Ducos, Savigny Sur Orge (FR)

(72) Inventor: Dominique Ducos, Savigny Sur Orge (FR)

(73) Assignee: MESSIER-BUGATTI-DOWTY, VELIZY VILLACOUBLAY (FR)

(21) Appl. No.: 13/704,164

(22) PCT Filed: Jun. 16, 2011
(86) PCT No.: PCT/EP2011/060072

§ 371 Date: Feb. 4, 2013

(30) Foreign Application Priority Data
Jun. 16, 2010 (FR) 1054776

(51) Int. Cl. B64C 25/62

(52) U.S. Cl. CPC B64C 25/62
USPC 244/104 FP

(57) ABSTRACT

An aircraft landing gear, characterized in that it comprises two rocker beams carrying wheels and mounted to pivot on at least one pivot of the landing gear, the landing gear including a shock absorber device comprising two connecting rods coupled to respective ones of the rocker beams, and at least one of the connecting rods being telescopic and forming a shock absorber. The two connecting rods also are coupled to a rocking crossbar pivotally mounted on a central pivot, the pivots of the rocker beams and the central pivot of the crossbar being mounted on a leg that is connected to the fuselage of the aircraft by means of two panels that are hinged to the leg and to the structure of the aircraft about axes that are perpendicular to the hinge axes of the rocker beams and that co-operate with the leg to form a deformable parallelogram system.

The invention relates to an aircraft main landing gear having two rocker beams and a deformable parallelogram structure.

### TECHNOLOGICAL BACKGROUND

In the field of military transport airplanes, aircraft are known, such as the C160 Transall or A400M airplanes for example, that have main landing gears that are fastened to a lateral structure of the fuselage. In general, the main landing gears are arranged on either side of the fuselage, and on each side they are arranged one behind another. Each landing gear generally comprises a rocker beam having one end that receives an axle carrying two wheels. The rocker beam is hinged about a transverse axis, either to a leg of the landing gear, or else directly to a structure that is secured to the fuselage. Under such circumstances, a retraction device pulls on the shock absorber connected to the rocker beam in order to pivot it towards a retracted position in which the rocker beam and the wheels are received inside a lateral fairing of the fuselage. If it is desired to have at least four wheels on each side of the fuselage, then at least two landing gears need to be provided on each side of the fuselage. It is therefore necessary either to provide two raising actuators and two members for stabilizing the landing gears in the landing position, which is heavy, or else to provide a mechanical linkage between the landing gears so as to enable them to be driven using a single drive actuator and enabling them to be stabilized with the help of a single stabilizer member, which is complex.

Main landing gears are also known that are fastened to a lateral structure of the fuselage and that include a leg on which the rocker beam is hinged, with a damper being coupled between the leg and the rocker beam. The leg is connected to the fuselage by means of two hinged panels co-operating with the leg to form a deformable parallelogram system. One such landing gear is described for example in document U.S. Pat. No. 2,752,112. That type of landing gear is to be found in aircraft such as the Boeing C17. In that aircraft, the rocker beam has two branches, a first branch that extends rearwards and carries two wheels and a second branch that extends rearwards and carries an additional wheel, the three wheels pivoting substantially about the same transverse axis. The assembly comprising the rocker beam and the wheels is thus very bulky laterally, and in order to gain space in the stowed position, the rocker beam is also pivotally mounted on the leg about an axis that is substantially vertical so as to enable the rocker beam to be turned through 90° during retraction of the landing gear. That arrangement is very complex.

It might be thought that a rocker beam could be adapted to such an landing gear with the rocker beam being hinged to the bottom portion of the leg and extending on either side of the leg, with each of the ends of the beam carrying a respective axle for carrying two wheels. Nevertheless, that arrangement would make it necessary to incorporate a shock absorber in the leg so that the rocker beam is hinged to the end of the shock absorber, thereby requiring the leg to be of a long length that is incompatible with the stowage volume available in the retracted position.

Wing landing gears are also known comprising a leg hinge-mounted under the wing about a hinge axis, with the bottom end of the leg carrying a pivot having two rocker beams hinged thereto, each rocker beam carrying one axle, one of them extending forwards and the other extending rearwards, e.g. of the kind to be found on the Caravelle or Nimrod airplanes. Such an landing gear is described for example in document FR 1 409 467. Specifically, the rocker beams are hinged to the end of a rod that is mounted to slide telescopically in the leg of the landing gear.

The landing gear includes a shock absorber device having two connecting rods coupled to respective ones of the rocker beams, at least one of the connecting rods being telescopic and forming a shock absorber, the two connecting rods also being coupled to a rocking crossbar pivotally mounted on a pivot of the leg of the landing gear. The assembly is pivotable as a whole about the hinge axis of the leg in order to be retracted into the structure of the airplane.

### OBJECT OF THE INVENTION

An object of the invention is to propose a fuselage landing gear combining the advantages of the above-described formulas.

### BRIEF DESCRIPTION OF THE INVENTION

In order to achieve this object, the invention provides an aircraft landing gear comprising two rocker beams carrying wheels and mounted to pivot on the landing gear, the landing gear including a shock absorber device comprising two connecting rods coupled to respective ones of the rocker beams, and at least one of the connecting rods being telescopic and forming a shock absorber, the two connecting rods also being coupled to a rocking crossbar pivotally mounted on a central pivot, the common pivot of the rocker beams and the central pivot of the crossbar being mounted on a leg that is connected to the fuselage of the aircraft by means of two panels that are hinged to the leg and to the structure of the aircraft about axes that are perpendicular to the hinge axes of the rocker beams and that co-operate with the leg to form a deformable parallelogram system.

Thus, by means of the combination of the invention, it is possible to retain a short leg, while nevertheless allowing the landing gear to carry four wheels that are carried in pairs one pair in front of the other pair, which is found to be compact.

### BRIEF DESCRIPTION OF THE FIGURES

The invention can be better understood in the light of the following description of the figures of the accompanying drawings, in which:

FIG. 1 is a side view of a fuselage landing gear in a particular embodiment of the invention, the landing gear being shown in the deployed position prior to landing, with two wheels being omitted for greater clarity;

FIG. 2 is a view analogous to FIG. 1, showing the landing gear in the deployed position after landing;

FIG. 3 is a perspective view of the landing gear as shown in FIG. 1;

FIG. 4 is a view identical to that of FIG. 3, with all the wheels being shown;

FIG. 5 is a front view of the landing gear in the deployed position prior to landing; and

FIG. 6 is a front view of the landing gear in the retracted position, the fuselage and the fairing for receiving the landing gear in the retracted position being sketched as dashed lines.

### DETAILED DESCRIPTION OF THE FIGURES

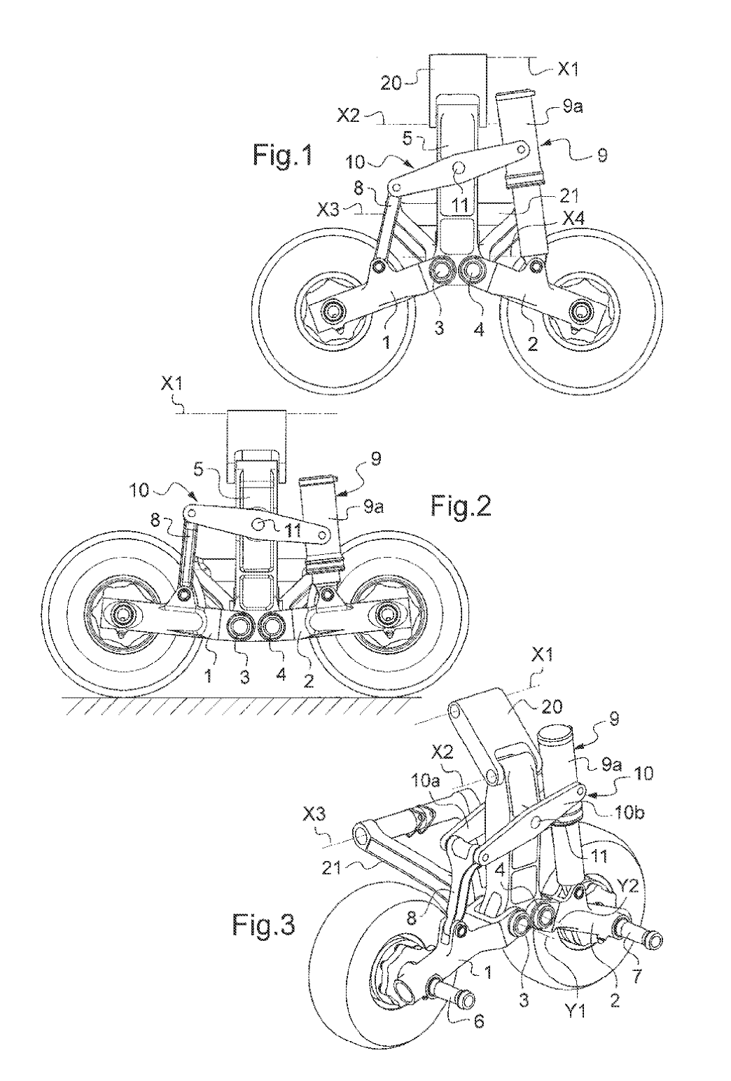

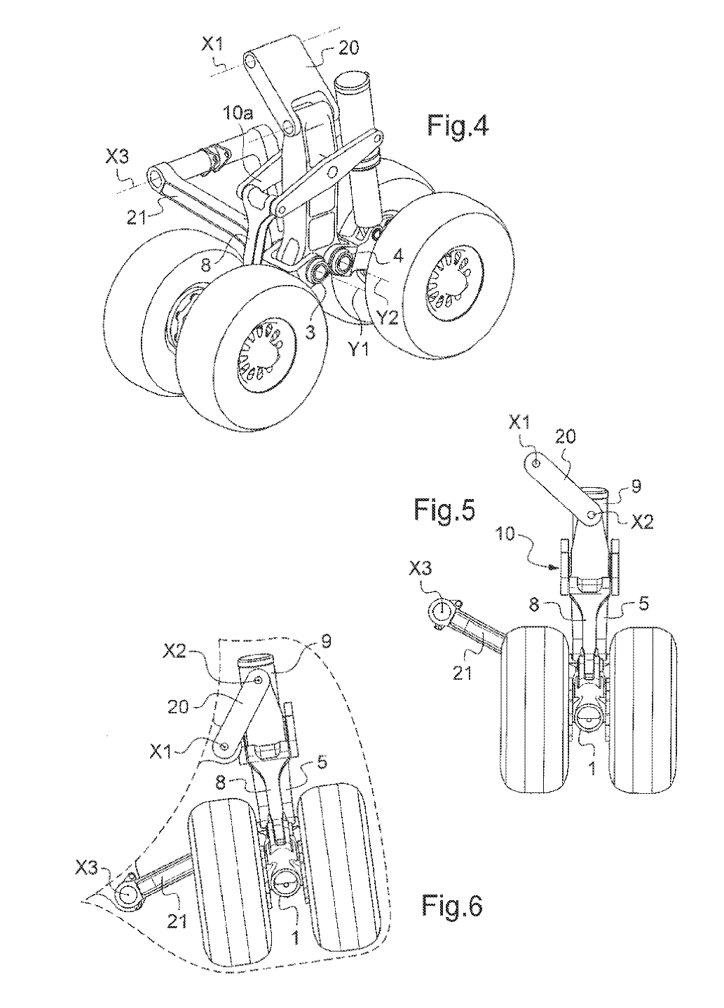

With reference to FIGS. 1, 2, 3, 4, and 5, the landing gear of the invention has two rocker beams 1, 2, both having respective proximal ends hinged to respective pivots 3, 4 arranged at the bottom portion of a leg 5, and distal ends carrying respective axles 6, 7, each receiving two wheels. In this example, the pivots 3 and 4 are distinct.

Connecting rods 8, 9 are coupled firstly to the rocker beams 1, 2 and secondly to the ends of a rocking crossbar 10 pivotally mounted on a central pivot 11 carried by the leg 5. In this example, the connecting rod 9 is a telescopic shock absorber, while the crossbar 10 has two flanks 10a, 10b extending on either side of the leg 5, the flanks carrying, at their ends, hinges for connecting to the connecting rod 8 and to the shock absorber 9. It should be observed that the shock absorber is hinged to the crossbar 10, not at its end but rather via lateral pivots extending from the flanks of the cylinder 9a of the shock absorber, which in this example are closer to the open bottom end of the cylinder than to its closed top end.

The assembly is of limited height, thereby making the landing gear very compact. All of the above-mentioned hinges are organized with axes that are all parallel to the pivot axes Y1 and Y2 between the rocker beams 1, 2 and the leg 5, and that extend in a horizontal direction that is transverse relative to a longitudinal axis of the aircraft.

The leg 5 is connected to the structure of the fuselage by means of two panels 20 and 21 that are hinged respectively to the fuselage about axes X1 and X3, and that are hinged to the leg 5 about axes X2 and X4, said axes being mutually parallel and extending substantially parallel to a longitudinal axis of the aircraft. The assembly forms a structure of the deformable parallelogram type, thereby enabling the landing gear to be deployed and retracted between a landing position as shown in FIG. 5 and a retracted position as shown in FIG. 6.

Naturally, the landing gear of the invention is fitted with a drive actuator to enable it to be moved from the deployed position to the retracted position, e.g. a drive actuator coupled between the fuselage and one of the panels 20, 21. In addition, the landing gear of the invention is fitted with means for stabilizing the landing gear in the deployed position, e.g. an alignment brake extending along one of the diagonals of the parallelogram formed by the panels 20, 21 and the leg 5 with the fuselage.

The invention is not limited to the above description, but on the contrary covers any variant coming within the ambit defined by the claims.

In particular, although it is stated that among the two connection rods coupled to the rocker beams and to the crossbar, one of them forms a shock absorber while the other is of fixed length, it would be equally possible to use two shock absorber-forming telescopic connecting rods, which would present the advantage of reducing the stroke of the shock absorbers, thus making it possible to use shorter shock absorbers.

Furthermore, although the rocker beams described above are mounted to pivot on respective pivots carried by the leg, it is entirely possible for the rocker beams to be mounted on a common pivot carried by the leg.

1. An aircraft landing gear, characterized in that it comprises two rocker beams carrying wheels and mounted to pivot on at least one pivot of the landing gear, the landing gear including a shock absorber device comprising two connecting rods coupled to respective ones of the rocker beams, and at least one of the connecting rods being telescopic and forming a shock absorber, the two connecting rods also being coupled to a rocking crossbar pivotally mounted on a central pivot, the pivot of the rocker beams and the central pivot of the rocking crossbar being mounted on a leg that is connected to the fuselage of the aircraft by means of two panels that are hinged to the leg and to the structure of the aircraft about axes that are perpendicular to the hinge axes of the rocker beams and that co-operate with the leg to form a deformable parallelogram system.

2. The aircraft landing gear according to claim 1, wherein the rocker beams are hinged to the leg via two distinct respective pivots.

3. The aircraft landing gear according to claim 1, wherein the connecting rod that forms a shock absorber includes a cylinder that is coupled to the rocking crossbar by pivots that extend from the flanks of the cylinder.

4. The aircraft landing gear according to claim 1, wherein the pivots of the cylinder are closer to an open end of said cylinder than they are to a closed end thereof.
